(19) United States
(12) Patent Application Publication
(10) Pub. No.: US 2004/0101356 A1
(43) Pub. Date: May 27, 2004

(54) Three-dimensional engaging device

(75) Inventor: Chen-Hsing Cheng, Taipei (TW)

Correspondence Address: QUINTERO LAW OFFICE, 1617 BROADWAY, 3RD FLOOR, SANTA MONICA, CA, 90404, US

(73) Assignee: BENQ Corporation

(21) Appl. No.: 10/637,128

(22) Filed: Aug. 8, 2003

(30) Foreign Application Priority Data
Nov. 22, 2002 (TW) 91218886

(51) Int. Cl. F16B 12/36; B25G 3/00; F16B 1/00

(52) U.S. Cl. 403/353

(57) ABSTRACT

A three-dimensional engaging device. The three-dimensional engaging device includes a first fastener and a second fastener. The first fastener includes a side wall, a first block, and a second block. The first and second blocks are respectively connected to the side wall. The second fastener engages the first fastener. The side wall constrains the second fastener in a direction x. The first block constrains the second fastener in a direction y, and the second block constrains the second fastener in a direction z. The x, y, and z axes are substantially perpendicular to each other.

### BACKGROUND OF THE INVENTION

1. Field of the Invention

The present invention relates to a three-dimensional engaging device, and in particular to an engaging device that constrains two covers in three dimensions.

2. Description of the Related Art

Electronic devices are designed to be small and lightweight, for both functional and aesthetic considerations. Many diverse interchangeable covers are available for exchanging the appearances of these electronic devices. Usually, screws, latches, or other engaging portions are used to fix or release the removable covers of these common electronic devices. Electronic devices that do not feature interchangeable covers are engaged by gluing.

When screws are used to connect covers, it is often necessary to screw out a lot of screws when changing covers. That is a complicated process, and suitable tools are needed sometimes. The screws are also difficult to replace if lost. Frequently removal and replacement can cause wear and tear on both the screws and the latches of the covers of the electronic devices. The appearance of the whole device is also negatively affected by the presence of screws. Finally, screws makes size reduction of the electronic device difficult.

When latches are used to connect covers, the latches are usually disposed on the body or sides of the electronic device and formed by injection molding. The latch only constrains two covers in one or two dimensions, and thus, additional screws are also required to constrain the device in the third direction. During installation, the latch is slightly pressed to connect the covers, however, there may be problems with gaps between the joints. Furthermore, due to injection molding, the strength of the latch is not strong enough, and additional screws are also necessary to increase strength. As a result, difficulties in dealing with screws arise again.

Thus, there remains a need for a three-dimensional engaging device to easily open and close the covers of the device without extra screws or tools.

### SUMMARY OF THE INVENTION

Accordingly, an object of the invention is to provide a three-dimensional engaging device that is applicable in various electronic devices without the need for screws or other components, providing an aesthetically pleasing appearance.

Another object of the invention is to provide a three-dimensional engaging device to easily and quickly engage the interchangeable covers of an electronic device.

Another object of the invention is to provide a three-dimensional engaging device to easily and quickly disengage the electronic device.

Another object of the invention is to provide a three-dimensional engaging device not visible from the device exterior, thereby providing an aesthetically pleasing appearance.

The present invention provides a three-dimensional engaging device, including a first fastener and a second fastener. The first fastener has a side wall, a first block, and a second block. The first and second blocks are respectively connected to the side wall. The second fastener is engaged with the first fastener. The side wall constrains the second fastener in a direction x. The first block constrains the second fastener in a direction y, and the second block constrains the second fastener in direction z. The x, y, and z axes are substantially perpendicular to each other.

The second fastener is a flexible hook. The first block of the first fastener is wedge-shaped.

Accordingly, the second fastener includes a body and a connecting portion connected to the body. The second fastener is h-shaped or U-shaped.

A hole is formed on the side wall of the first fastener, and the body of the second fastener faces the hole of the first fastener when the first fastener and the second fastener are engaged.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic view showing a three-dimensional engaging device according to the first embodiment of the present invention;

FIG. 1B is an enlarged view of the first fastener in FIG. 1A;

FIG. 1C is an enlarged view of the second fastener in FIG. 1A;

FIG. 2A is a schematic view showing a three-dimensional engaging device according to the second embodiment of the present invention;

FIG. 2B is an enlarged view of the first fastener in FIG. 2A; and

FIG. 2C is an enlarged view of the second fastener in FIG. 2A.

### DETAILED DESCRIPTION OF THE INVENTION

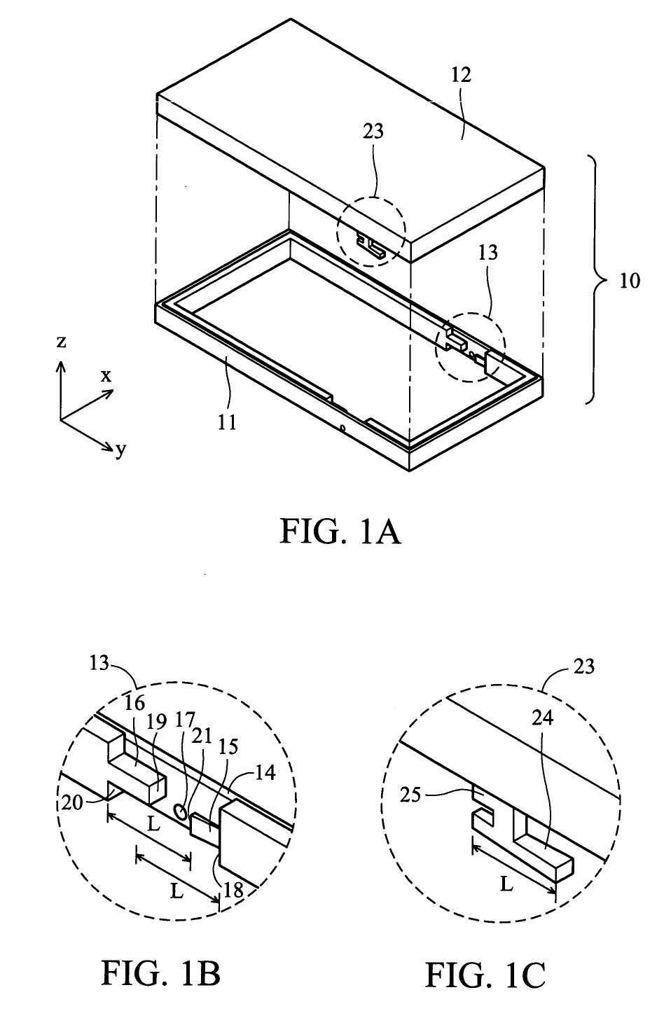

FIG. 1A is a schematic view showing a three-dimensional engaging device according to the first embodiment of the present invention. FIG. 1A shows covers of an electronic device 10, for example an optical disk drive, with the three-dimensional engaging device of the present invention. FIG. 1B is an enlarged view of the first fastener 13 in FIG. 1A. FIG. 1C is an enlarged view of the second fastener 23 in FIG. 1A.

The three-dimensional engaging device of the present invention is applicable in various electronic devices, such as optical disk drive, mobile phone, personal digital assistant (PDA), floppy disk drive, liquid crystal display (LCD), scanner, or overhead projector. The covers of the mentioned devices according to the present invention provide easy engagement and disengagement for changing covers or repair access.

As shown in FIG. 1A, an electronic device 10 according to the first embodiment includes a first cover 11, and a second cover 12. The first cover 11 has a first fastener 13, and the second cover 12 has a second fastener 23.

As shown in FIG. 1B, the first fastener 13 includes a side wall 14, a first block 15, and a second block 16. Both the first block 15 and the second block 16 are connected to the side wall 14. Also, a hole 17 is formed on the side wall 14. The first block 15 in FIG. 1B is wedge-shaped. That is, a portion of the first block 15 near the hole 17 is thicker than the opposite portion. In other words, the first block 15 has a slanted face, and the slanted face is positioned to face the second fastener 23, as shown in FIG. 1C and described hereinafter.

As shown in FIG. 1C, the second cover 12 has a second fastener 23. In this embodiment, the second fastener 23 is h-shaped. The second fastener 23 has a body 24 and a connecting portion 25. The body 24 of the second fastener 23 is wedge-shaped, and the connecting portion 25 of the second fastener 23 is L-shaped. The body 24 and the connection portion 25 are integrated into one unit. The leftward portion of the body 24 in FIG. 1C is thinner than the rightward portion thereof. The body 24 of the second fastener 23 is positioned to face the slanted face of the first block 15 of the first fastener 13.

The following description describes the method of applying the engaging device to connect two covers of an electronic device.

As shown in FIG. 1A, axes x, y, z are perpendicular to each other. The second fastener 23 is a flexible hook; thus, the second fastener 23 elastically engages or disengages between the first block 15 and the second block 16 of the first fastener 13. According to FIG. 1B and FIG. 1C, the length of the body 24 of the second fastener 23 is L. The distance between the inner surface 18 of the first cover 11 and the side wall 19 of the second block 16 is also L. The distance between the first face 20 of the second block 16 and the second face 21 of the first block 15 is also L. When the two covers are combined, the second fastener 23 is inserted into the first fastener 13 in direction z. In detail, the body 24 is moved in direction y until both of the first and second fasteners are fixed. At this time, the length L of the body 24 corresponds to the distance L between the the second block 16 and the first block 15 in FIG. 1B. The the body 24 and the connecting portion 25 of the second fastener 23 surrounds the second block 16 of the first fastener 13. In other words, the shapes of the first fastener 13 and the second fastener 24 match to each other. The first block 15 of the first fastener 13 is wedge-shaped to allow the body 24 of the second fastener 23 to move in direction y but is fixed after moving to a predetermined position. The body 24 of the second fastener 23 is also wedge-shaped to achieve the same result.

In the first embodiment, when the first cover 11 engages with the second cover 12, the side wall 14 of the first cover 11 constrains the second fastener 23 on the second cover 12 in direction x. The first block 15 constrains the second fastener 23 in direction y. The second block 16 further constrains the second fastener 23 in direction z so that the two fasteners confine each other in three directions. When the covers are engaged, the connection portion 25 of the second fastener 23 is disposed above the second block 16 on the first fastener 13. Moreover, the shapes of the first block 15 and the second block 16 correspond to the shape of the second fastener 23 so that the covers are firmly engaged.

When the first cover 11 and the second cover 12 are firmly engaged, the covers are confined in three directions, and, thus secured without any additional components. When the second fastener 23 connects the first cover 11 with the second cover 12, the hole 17 directly faces the body 25 of the second fastener 23. At this time, the second fastener 23 is concealed inside the first cover 11. That is, the second fastener 23 is disposed inside the first fastener 13. Thus, the engaging device is not visible on the exterior surface of the device, maintaining an aesthetically pleasing appearance. When disengaging the covers of the present invention, only a pin-shaped tool is needed to insert into the hole 17 in direction x to slightly depress the concealed second fastener 23 in the first cover 11, such that the covers are easily and quickly separated.

Thus, the three-dimensional engaging device of the present invention does not require complicated process using screws to secure the device and provides quick and convenient disengagement or engagement of the covers. The appearance is not affected by the engaging device.

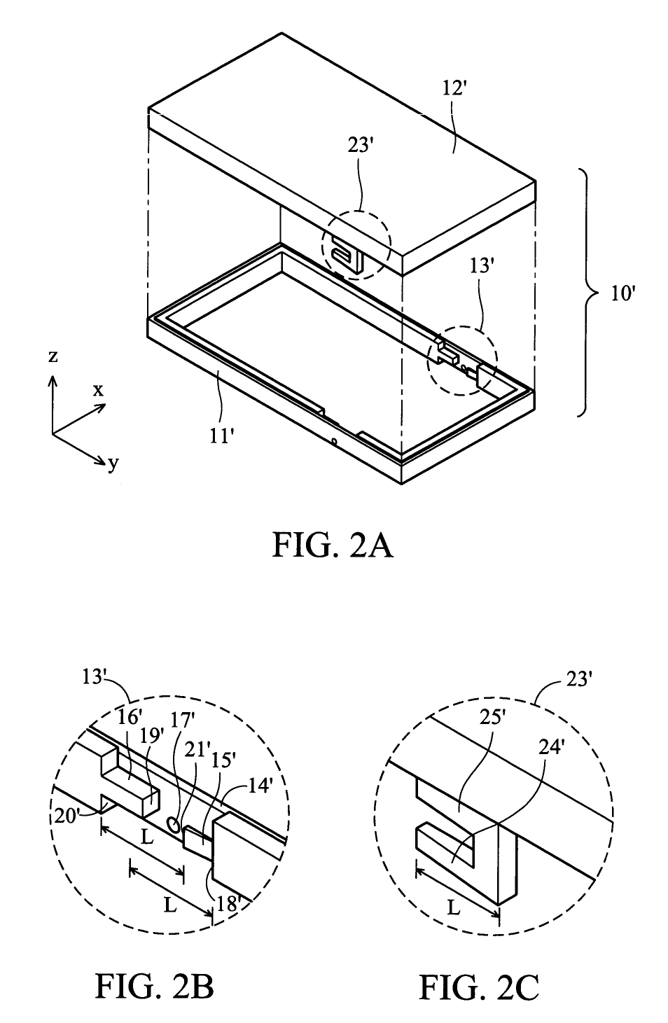

FIG. 2A shows a second embodiment of the present invention. FIG. 2B is an enlarged view of the first fastener 13′ in FIG. 2A. FIG. 2C is an enlarged view of the second fastener 23′ in FIG. 2A.

As shown in FIG. 2A, the electronic device 10 includes a first cover 11′ and a second cover 12′. The first cover 11′ has a first fastener 13′, and the second cover 12′ has a second fastener 23′.

As shown in FIG. 2B, the first fastener 13′ includes a side wall 14′, a first block 15′, and a second block 16′. Both the first block 15′ and the second block 16′ are connected to the side wall 14′. Also, a hole 17′ is formed on the side wall 14′. The first block 15′ in FIG. 2B is wedge-shaped. That is, a portion of the first block 15′ near the hole 17′ is thicker than the opposite portion, that is, the first block 15′ has a slanted face faced to the second fastener 23′, as shown in FIG. 2C.

As shown in FIG. 2C, the second cover 12′ has a second fastener 23′. In the second embodiment, the second fastener 23′ is U-shaped. The second fastener 23′ has a body 24′ and a connecting portion 25′. The body 24′ is wedge-shaped, and the connecting portion 25′ is block-shaped. The body 24′ and the connection portion 25′ are integrated into one unit. The leftward portion of the body 24′ in FIG. 2C is thinner than the rightward portion thereof, the thicker part of the body 24′ faces the slanted face of the first block 15′ of the first fastener 13′.

The following description reveals the method of applying the engaging device to connect two covers of an electronic device.

As shown in FIG. 2A, x, y, and z axes are perpendicular to each other. The second fastener 23′ is a flexible hook; thus, the second fastener 23′ elastically is engaged or disengaged between the first block 15′ and the second block 16′ of the first fastener 13′. According to FIG. 2B and FIG. 2C, the length of the body 24′ of the second fastener 23′ is L. The distance between the inner surface 18′ of the first cover 11′ and the side wall 19′ of the second block 16′ is also L. The distance between the first face 20′ of the second block 16′ and the second face 21′ of the first block 15′ is also L. When the two covers are combined, the second fastener 23′ is inserted into the first fastener 13′ in direction z. Then, the body 24′ is moved in direction y until both fasteners are fixed. At this moment, the length L of the body 24′ corresponds to the distance L between the second block 16′ and the first block 15′ in FIG. 1B. The body 24′ and the connecting portion 25′ of the second fastener 23′ surrounds the second block 16′ of the first fastener 23′. In other words, first fastener 13′ and the second fastener 24′ match to each other. The first block 15′ of the first fastener 23′ is wedge-shaped to allow the body 24′ of the second fastener 23′ to move in direction y, but is secured to a fixed position. The body 24′ of the second fastener 23′ is also wedge-shaped to achieve the same result.

In the second embodiment, when the first cover 11′ engages with the second cover 12′, the side wall 14′ of the first cover 11′ constrains the second fastener 23′ on the second cover 12′ in direction x. The first block 15′ constrains the second fastener 23′ in direction y. The second block 16′ further constrains the second fastener 23′ in direction z. The shapes of the first block 15′ and the second block 16′ correspond to the shape of the second fastener 23′ so that the covers are firmly engaged.

When the first cover 11′ and the second cover 12′ are firmly engaged, the covers are confined and secured in three directions. When the second fastener 23′ connects the first cover 11′ with the second cover 12′, the hole 17′ directly faces the body 25′ of the second fastener 23′. At this time, the second fastener 23′ is concealed inside the first cover 11′. That is, the second fastener 23′ is disposed inside the first fastener 13′. Thus, the engaging portions are not visible on the external surface of the device, preserving the aesthetically pleasing appearance. When disengaging the covers of the present invention, only a pin-shaped tool need be inserted into the hole 17′ in direction x to depress the concealed second fastener 23′ in the first cover 11, to easily and quickly separate the covers.

Hence, the three-dimensional engaging device of the present invention does not require complicated process to secure or disengage the covers. The appearance of the device is unaffected by the engaging device.

When the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A three-dimensional engaging device, comprising:
a first fastener having a side wall, a first block, and a second block, the first and second blocks being respectively connected to the side wall; and
a second fastener engaged with the first fastener,
wherein the side wall of the first faster constrains the second fastener in a direction x; the first block constrains the second fastener in a direction y; and the second block constrains the second fastener in a direction z, and x, y, and z directions are substantially perpendicular to each other.

2. The engaging device as claimed in claim 1, wherein the second fastener is a flexible hook.

3. The engaging device as claimed in claim 2, wherein the first block is wedge-shaped.

4. The engaging device as claimed in claim 2, wherein the second fastener includes a body and a connecting portion connected to the body.

5. The engaging device as claimed in claim 4, wherein the second fastener is h-shaped.

6. The engaging device as claimed in claim 4, wherein the second fastener is U-shaped.

7. The engaging device as claimed in claim 4, wherein a hole is formed on the side wall of the first fastener, and the body of the second fastener faces the hole of the first fastener when the first fastener and the second fastener are engaged.

8. The engaging device as claimed in claim 1, wherein the second fastener is contained inside the first fastener when the first fastener and the second fastener are engaged.
